(19) United States
(12) Patent Application Publication
(10) Pub. No.: US 2025/0211841 A1
(43) Pub. Date: Jun. 26, 2025

(54) IMAGE PICKUP APPARATUS

(71) Applicant: CANON KABUSHIKI KAISHA, Tokyo (JP)

(72) Inventor: ATSUTO NODA, Kanagawa (JP)

(21) Appl. No.: 18/962,290

(22) Filed: Nov. 27, 2024

(30) Foreign Application Priority Data
Dec. 25, 2023 (JP) 2023-218001

(51) Int. Cl. H04N 23/52; H04N 23/54

(52) U.S. Cl. CPC H04N 23/52; H04N 23/54

(57) ABSTRACT

An image pickup apparatus includes a plurality of electric elements mounted on a mounting surface on an image side of an image sensor, each with a different protruding amount from the mounting surface, a heat dissipation sheet contacting the electric elements, and a heat dissipation member arranged to sandwich the heat dissipation sheet with a substrate arranged on the image side of the image sensor. Part of the heat dissipation sheet is pressed by part of the electric elements and an attachment surface provided on the heat dissipation member. When viewed from the image side, the image pickup apparatus includes a first area where the heat dissipation sheet overlaps with the heat dissipation member and a second area where the heat dissipation sheet is exposed. Among the electric elements contacting the heat dissipation sheet, a first electric element with the largest protruding amount is in the second area.

### BACKGROUND

### Technical Field

The present disclosure relates to a heat dissipation structure of an image pickup apparatus.

### Description of Related Art

Conventionally, to dissipate heat from an image sensor, a heat dissipation sheet is brought into contact with an electronic substrate or electric elements provided on the image sensor, and a heat dissipation metal plate is arranged to sandwich the heat dissipation sheet (see, for example, Japanese Patent Laid-Open No. 2016-19005).

In the conventional configuration, to ensure heat dissipation functionality, it is necessary to have the heat dissipation sheet in contact with both the heat dissipation metal plate and the image sensor, but, when the heat dissipation sheet is compressed between the heat dissipation metal plate and the image sensor, repulsive force of the heat dissipation sheet acts on both the heat dissipation metal plate and the image sensor. When a plurality of electric elements of varying heights are arranged on the image sensor, higher repulsive force may act on a taller electric element, while a lower electric element may risk losing contact with the heat dissipation sheet.

Additionally, a method has been known in which, after adjusting a relative position of the image sensor with respect to a holding metal plate by providing clearance, the clearance is filled with an adhesive to secure the image sensor without contact with the holding metal plate. In such a method, as described above, if repulsive force is applied to the image sensor, there is a risk that the relative positional relationship between the image sensor and the holding metal plate may change due to adhesive peeling or deformation.

### SUMMARY

An image pickup apparatus according to one aspect of the present disclosure includes an image sensor configured to image an object image formed by an optical system, a substrate arranged on an image side of the image sensor, a plurality of electric elements mounted on a mounting surface on the image side of the image sensor, each with a different protruding amount from the mounting surface, a heat dissipation sheet in contact with the plurality of electric elements, and a heat dissipation member arranged to sandwich the heat dissipation sheet with the substrate. The heat dissipation member includes an attachment surface in contact with the heat dissipation sheet. Part of the heat dissipation sheet is pressed by part of the plurality of electric elements and the attachment surface. When viewed from the image side, the image pickup apparatus includes a first area where the heat dissipation sheet overlaps with the heat dissipation member and a second area where the heat dissipation sheet is exposed without overlapping with the heat dissipation member. Among the plurality of electric elements in contact with the heat dissipation sheet, a first electric element with the largest protruding amount is located in the second area.

Further features of various embodiments of the disclosure will become apparent from the following description of exemplary embodiments with reference to the attached drawings.

### BRIEF DESCRIPTION OF THE DRAWINGS

FIG. 1 is a perspective view of an image pickup apparatus according to an embodiment of the present disclosure.

FIG. 2 is a perspective view of a part of an internal structure of the image pickup apparatus.

FIG. 3 is a sectional view of a lens barrel.

FIGS. 4A and 4B are exploded perspective views of the lens barrel and an image sensor unit.

FIG. 5 is a rear view of a part of the internal structure of the image pickup apparatus.

FIG. 6 is an exploded perspective view of a part of the internal structure of the image pickup apparatus.

FIG. 7 is a sectional view of the image sensor unit.

FIGS. 8A and 8B are exploded perspective views of the image sensor unit.

FIGS. 9A and 9B are explanatory diagrams of a structure surrounding the image sensor.

FIGS. 10A and 10B are explanatory diagrams of the image sensor unit.

FIG. 11 is a diagram illustrating an attachment position of a heat dissipation sheet.

FIG. 12 is a partial sectional view illustrating a configuration in which the heat dissipation sheet and a heat dissipation metal plate are set according to a large electric element.

### DETAILED DESCRIPTION

Referring now to the accompanying drawings, a detailed description will be given of examples according to the disclosure. Corresponding elements in respective figures will be designated by the same reference numerals, and a duplicate description thereof will be omitted.

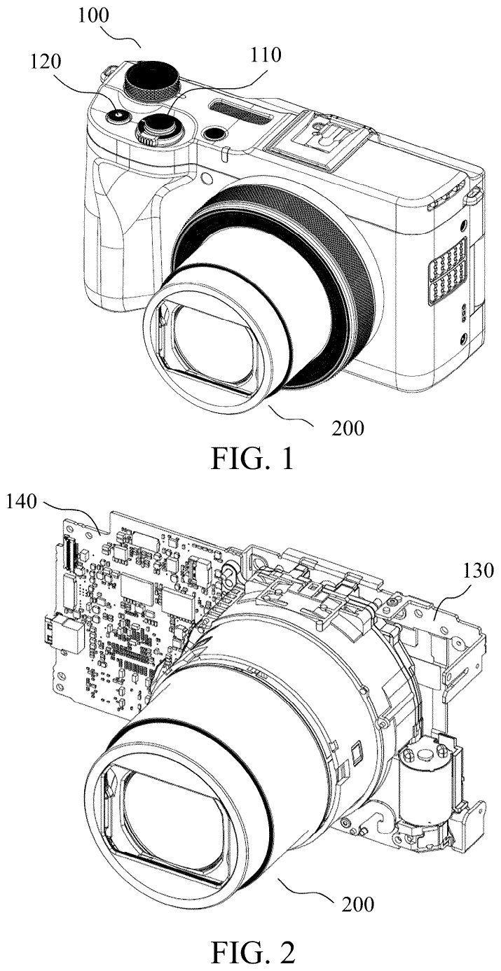

FIG. 1 is a perspective view of an image pickup apparatus 100 according to an embodiment of the present disclosure. The image pickup apparatus 100 includes a lens barrel (image pickup optical system barrel) 200. Additionally, the image pickup apparatus 100 is equipped with a release button 101 for a photographer to initiate shooting and a video start button 102 to start video recording.

FIG. 2 is a perspective view of a part of an internal structure, which includes the lens barrel 200, of the image pickup apparatus 100. The internal structure of the image pickup apparatus 100 includes a main metal plate 130 and a main substrate 140. The lens barrel 200 is positioned and either fixed or biased to the main metal plate 130 via screws or similar fasteners.

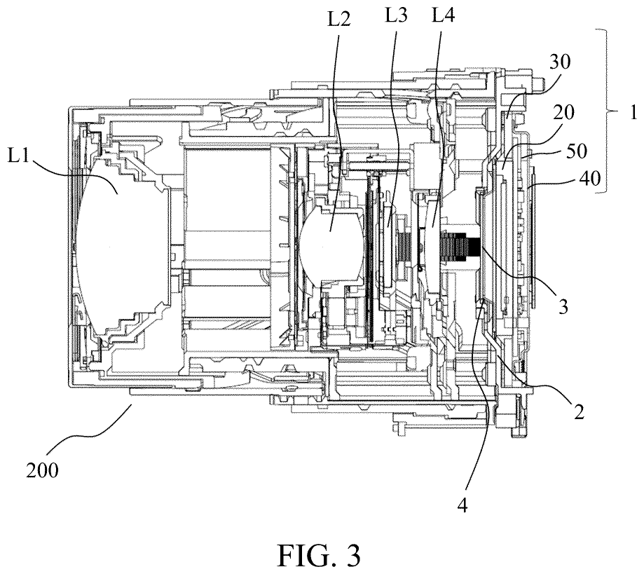

FIG. 3 is a sectional view of the lens barrel 200. The lens barrel 200 includes an image pickup optical system composed of a four-group lens optical system that has, in order from an object side (front) to an image side (rear), a first lens group L1, a second lens group L2, a third lens group L3, and a fourth lens group L4. Positioned on the image side of the image pickup optical system is an image sensor unit 1, which includes an image sensor 20 that captures an optical image (object image) formed by the image pickup optical system to generate image data. The image sensor unit 1 is constructed integrally with the image sensor 20, an image sensor holding metal plate (holding member) 30, a heat dissipation metal plate (heat dissipation member) 40, and a heat dissipation sheet 50. In this embodiment, the image sensor holding metal plate 30 is made of metal, although it may alternatively be made of resin.

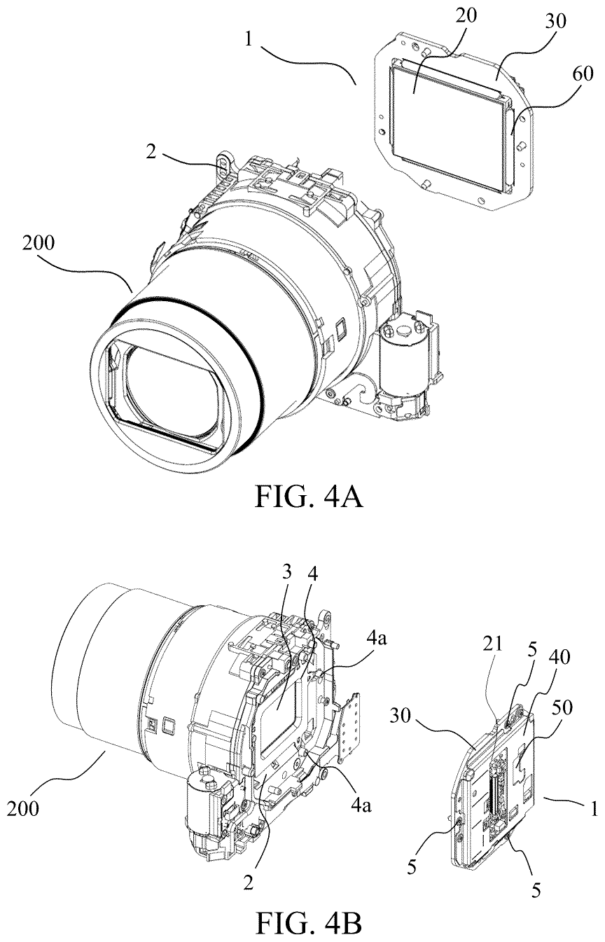

FIGS. 4A and 4B are exploded perspective views of the lens barrel 200 and the image sensor unit 1. The image sensor unit 1 is adjustably assembled onto an image sensor holding frame 2, which is positioned on the image side of the lens barrel 200. The image sensor holding frame 2 is formed with an opening. An optical filter 3, such as an infrared cut filter or a low-pass filter, is provided in the opening formed in the image sensor holding frame 2. The image sensor unit 1 is positioned a predetermined distance from the optical filter 3 on the image side. A sealing member 4 is provided between the optical filter 3 and the image sensor 20. The sealing member 4, made of an elastic material such as rubber, includes a plurality of arms 4a. The arms 4a are sandwiched between the image sensor holding metal plate 30 and the image sensor holding frame 2 while being compressed. Thereby, the image sensor holding metal plate 30 is biased in a direction away from the image sensor holding frame 2. The image sensor holding metal plate 30 is fixed to the image sensor holding frame 2 with a plurality of adjustment screws 5. Since the image sensor holding metal plate 30 is biased away from the image sensor holding frame 2, adjusting tightness of the adjustment screws 5 allows for tuning height and tilt of the image sensor holding metal plate 30. Once the image sensor holding metal plate 30 is adjusted to the appropriate position, an adhesive or similar means can be applied to secure the adjustment screws 5, thereby fixing a position of the image sensor holding metal plate 30. In this manner, the position of the image sensor holding metal plate 30, integrally included in the image sensor unit 1, can be adjusted and fixed, performing positioning of the image sensor unit 1.

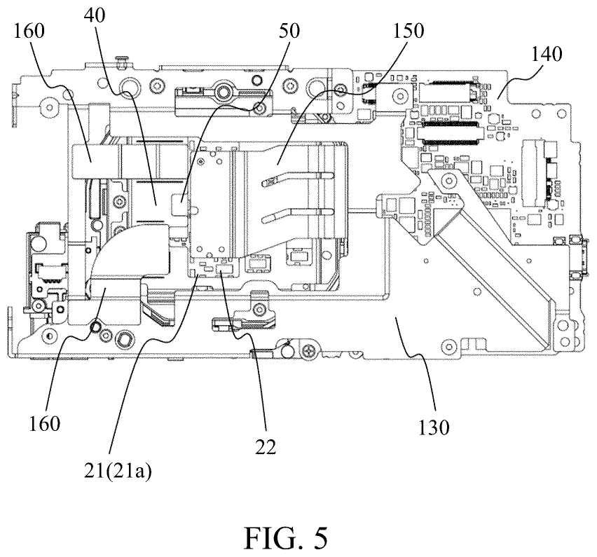

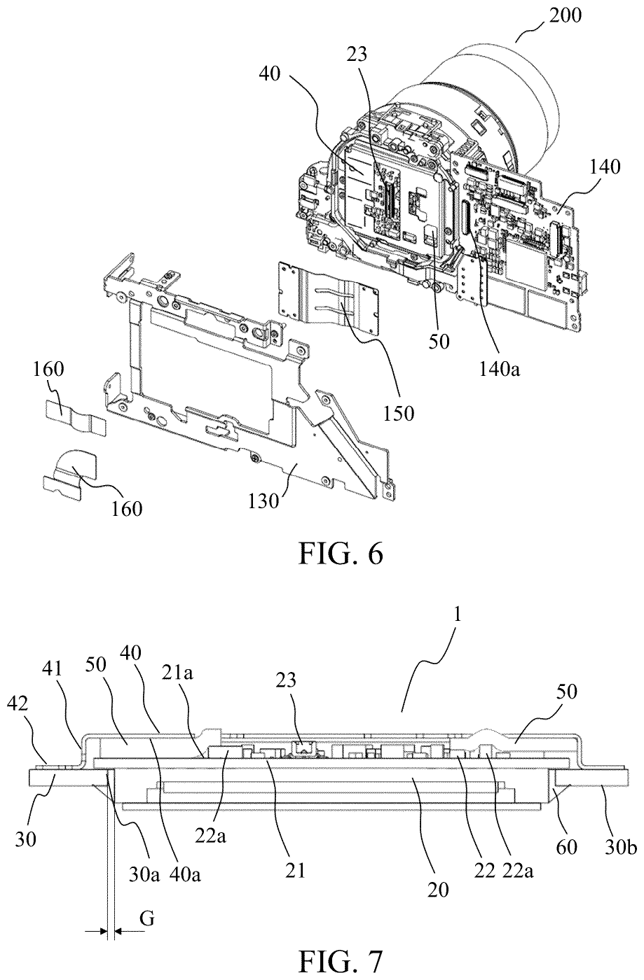

Below is an explanation of a heat dissipation structure of the image sensor unit 1 to the main body. FIG. 5 is a rear view of a part of the internal structure of the image pickup apparatus 100. FIG. 6 is an exploded perspective view of a part of the internal structure of the image pickup apparatus 100.

On the image side of the image sensor 20, an imaging substrate 21 is provided. Various electric elements 22 of different sizes are mounted on a mounting surface 21a on the image side of the imaging substrate 21. Additionally, a substrate connector 23 is mounted on the mounting surface 21a. The substrate connector 23 is connected to the main substrate 140 via a substrate connector 140a provided on the main substrate 140 and a flexible substrate 150. The heat dissipation sheet 50 is attached to the mounting surface 21a. The heat dissipation metal plate 40 is arranged to cover the mounting surface 21a and is fixed to the image sensor holding metal plate 30 with screws or similar fasteners. The heat dissipation sheet 50 is sandwiched between the mounting surface 21a and the heat dissipation metal plate 40, being partially compressed in an optical axis direction.

The heat dissipation metal plate 40 is connected to the main metal plate 130 via a heat transfer member 160, such as a graphite sheet. This allows heat generated by the image sensor 20 and the imaging substrate 21 to dissipate by diffusing through the heat dissipation sheet 50, the heat dissipation metal plate 40, and the heat transfer member 160 to the main metal plate 130.

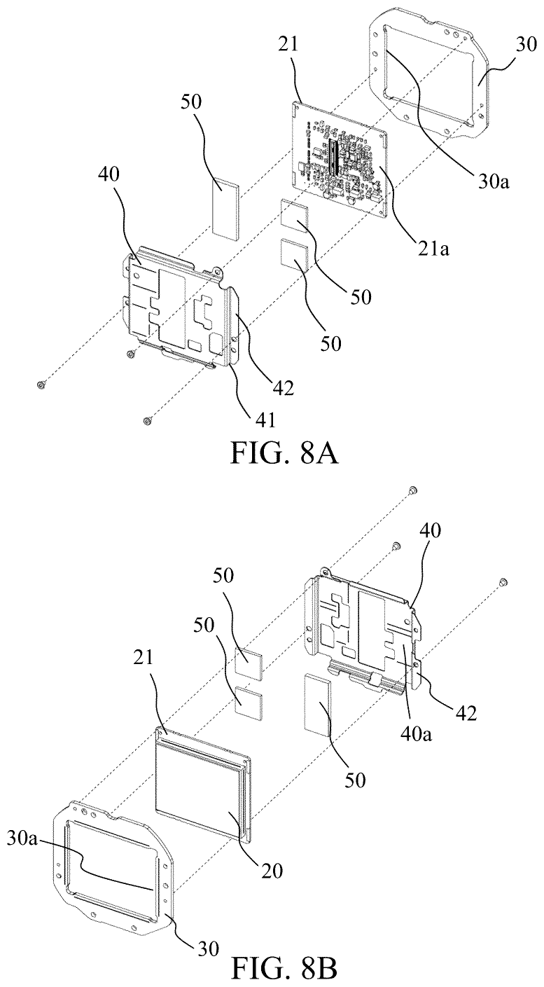

The structure of the image sensor unit 1 will be described below. FIG. 7 is a sectional view of the image sensor unit 1. FIGS. 8A and 8B are exploded perspective views of the image sensor unit 1.

The image sensor holding metal plate 30 is a rectangular shape and has an opening 30a formed in its center. Inside the opening 30a, the image sensor 20 is positioned. The image sensor 20 is arranged with a predetermined clearance (gap) G relative to the image sensor holding metal plate 30. The image sensor 20 and the image sensor holding metal plate 30 are positioned in both the optical axis direction and a direction orthogonal to the optical axis using an unillustrated positioning jig. In this state, an adhesive 60 is applied (filled) between each corner and side of the image sensor 20 and the opening 30a of the image sensor holding metal plate 30, securing the image sensor 20 to the image sensor holding metal plate 30 upon curing the adhesive 60. A UV-curing adhesive, for example, may be used as the adhesive 60, but the present disclosure is not limited thereto.

The adhesive 60 is applied from the object side of the image sensor 20. When part of the adhesive 60 adheres to and coats an object-side surface 30b of the image sensor holding metal plate 30, the bonding strength can be increased. Especially, this enhances strength against loads pushing the image sensor 20 toward the image side relative to the image sensor holding metal plate 30. However, the effect of enhanced bonding strength is relatively weak against loads pushing the image sensor 20 toward the object side relative to the image sensor holding metal plate 30. Thus, to improve bonding reliability, it is effective to reduce the load pushing the image sensor 20 toward the object side relative to the image sensor holding metal plate 30. As described above, the heat dissipation sheet 50 is sandwiched between the imaging substrate 21 and the heat dissipation metal plate 40, being partially compressed in the optical axis direction. Compression of the heat dissipation sheet 50 in the optical axis direction generates an elastic repulsion force, which applies a load pushing the image sensor 20 toward the object side relative to the image sensor holding metal plate 30. Thus, it is preferable to reduce the elastic repulsion force generated by compressing the heat dissipation sheet 50.

The heat dissipation metal plate 40 includes a flat portion with an attachment surface 40a that contacts the heat dissipation sheet 50, a bent-up portion 41 extending from an end of the flat portion in an object side direction (along the optical axis), and a flange portion 42 extending outward in the direction orthogonal to the optical axis from the end of the bent-up portion 41. The flange portion 42 is configured to contact the image sensor holding metal plate 30 and is fixed to the image sensor holding metal plate 30 using screws or similar fasteners.

With this configuration, the image sensor unit 1 can be handled as an integrated unit. As described above, the image sensor holding metal plate 30 is positioned and fixed relative to the image sensor holding frame 2, but since the image sensor holding metal plate 30 is adjusted integrally as part of the image sensor unit 1, adjustments do not affect the elastic repulsion force of the heat dissipation sheet 50 included in the image sensor unit 1. If the heat dissipation sheet 50 and the heat dissipation metal plate 40 were not included in the image sensor unit 1 and were instead fixed to, for example, the main metal plate 130, changes in the adjustment position of the image sensor 20 and the image sensor holding metal plate 30 would alter the compression amount of the heat dissipation sheet 50, causing variations in elastic repulsion force. Additionally, depending on the adjustment position of the image sensor 20, there could be issues such as adhesive peeling or changes in contact between the heat dissipation sheet 50 and the imaging substrate 21, potentially resulting in reduced heat dissipation performance.

Below is an explanation of the configuration of the imaging substrate 21, the heat dissipation sheet 50, the heat dissipation metal plate 40, and surrounding components.

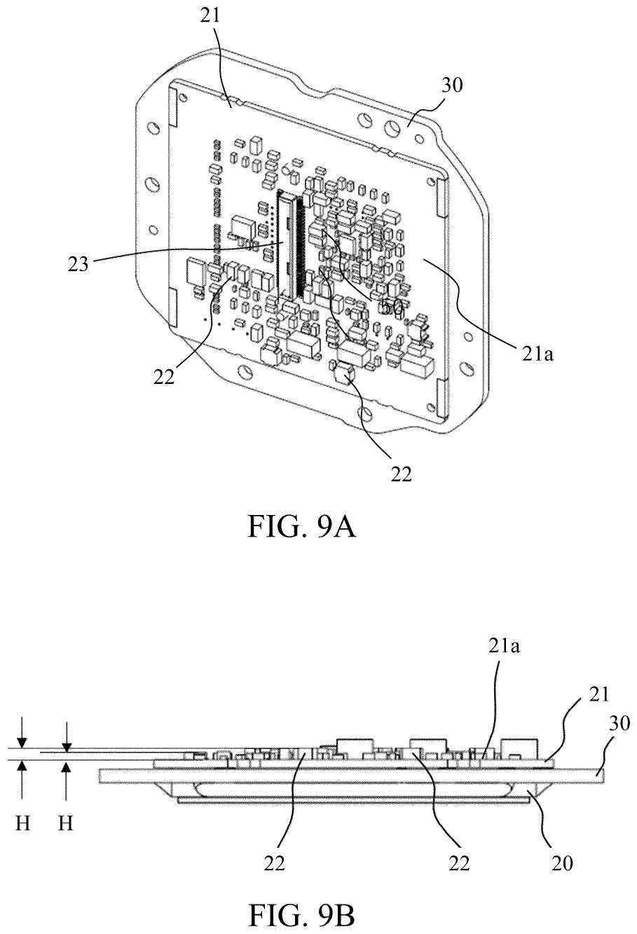

FIGS. 9A and 9B respectively illustrate a perspective view and a side view of the structure around the image sensor 20. As previously mentioned, the plurality of electric elements 22 and the substrate connector 23 are mounted on the mounting surface 21a of the imaging substrate 21, which is positioned on the image side of the image sensor 20. As illustrated in FIG. 9B, the electric elements 22 include elements with varying heights in the optical axis direction (protruding amount H from the mounting surface 21a). In other words, both taller electric elements 22 and shorter electric elements 22 coexist, protruding to different heights from the mounting surface 21a.

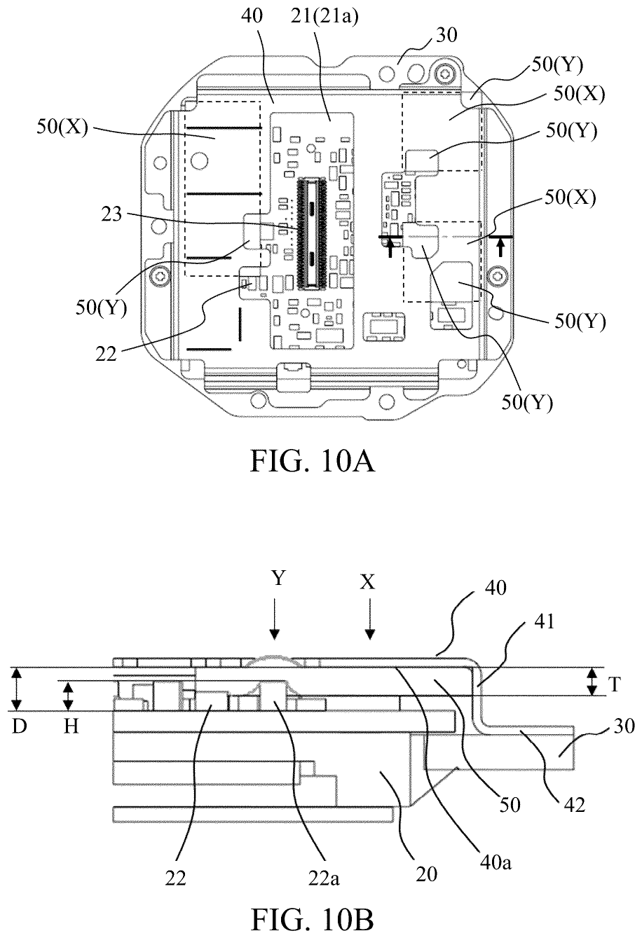

FIGS. 10A and 10B are explanatory diagrams of the image sensor unit 1. FIGS. 10A and 10B respectively illustrate a rear view and a partial sectional view of the image sensor unit 1. The heat dissipation sheet 50 is arranged to overlap with the plurality of electric elements 22 when viewed from the image side. The heat dissipation sheet 50 is rectangular (or substantially rectangular) with thickness and elasticity. Designing the heat dissipation sheet 50 in a simple shape such as a rectangle enhances efficiency in creating the heat dissipation sheet 50. However, when the heat dissipation sheet 50 is a simple rectangle, it may overlap with electric elements 22 of varying sizes when viewed from the image side. For instance, if the tallest electric element 22a among the electric elements 22 overlaps with the heat dissipation sheet 50 when viewed from the image side, creating holes or an L-shape in the heat dissipation sheet 50 to avoid overlap with the first electric element 22a would complicate the design.

In this embodiment, in the state where the heat dissipation sheet 50 and the heat dissipation metal plate 40 are assembled on the image side of the imaging substrate 21, when viewed from the image side, an area, where the heat dissipation sheet 50 overlaps with the heat dissipation metal plate 40 and remains unexposed, is designated as an area X (first area). Additionally, an area, where the heat dissipation sheet 50 does not overlap with the heat dissipation metal plate 40 and remains exposed, is designated as an area Y (second area). In FIGS. 10A and 10B, the area X, where the heat dissipation sheet 50 overlaps with the heat dissipation metal plate 40 and is invisible from the image side, is indicated by dashed lines, while the area Y, where the heat dissipation sheet 50 is exposed when viewed from the image side, is shown with solid lines.

As described above, the heat dissipation metal plate 40 sandwiches the heat dissipation sheet 50 with the imaging substrate 21 while compressing the heat dissipation sheet 50. The heat dissipation sheet 50 adheres to the attachment surface 40a of the heat dissipation metal plate 40 and contacts the plurality of electric elements 22 mounted on the imaging substrate 21. As a result, heat generated by the electric elements 22 is transferred through the heat dissipation sheet 50 to the heat dissipation metal plate 40.

In this embodiment, when viewed from the image side, the tallest electric element 22a among the electric elements 22 that overlap with the heat dissipation sheet 50 is positioned in area Y, where the heat dissipation sheet 50 does not overlap with the heat dissipation metal plate 40. In the area Y, part of the heat dissipation sheet 50 protrudes beyond the attachment surface 40a as it is pressed by the electric element 22. Consequently, this reduces the compression amounts of the heat dissipation sheet 50.

It is easier to precisely determine the attachment position of the heat dissipation sheet 50 by assembling the heat dissipation metal plate 40 with the heat dissipation sheet 50 pre-attached to the attachment surface 40a, rather than first placing the heat dissipation sheet 50 on the imaging substrate 21 and then assembling the heat dissipation metal plate 40.

Additionally, it is preferable for the substrate connector 23 to be centrally positioned on the imaging substrate 21 with the heat dissipation sheet 50 arranged on both sides of the substrate connector 23. For example, if the substrate connector 23 is positioned slightly off-center and the heat dissipation sheet 50 of sufficient size to achieve equivalent heat dissipation performance is placed only on one side, the elastic repulsion force generated by the compression of the heat dissipation sheet 50 will be concentrated on that side. In that case, adhesive detachment and displacement of the image sensor 20 are more likely to occur. In this embodiment, by placing the substrate connector 23 at the center of the imaging substrate 21 and arranging the heat dissipation sheet 50 on both sides, the load is balanced, reducing adhesive detachment and displacement of the image sensor 20.

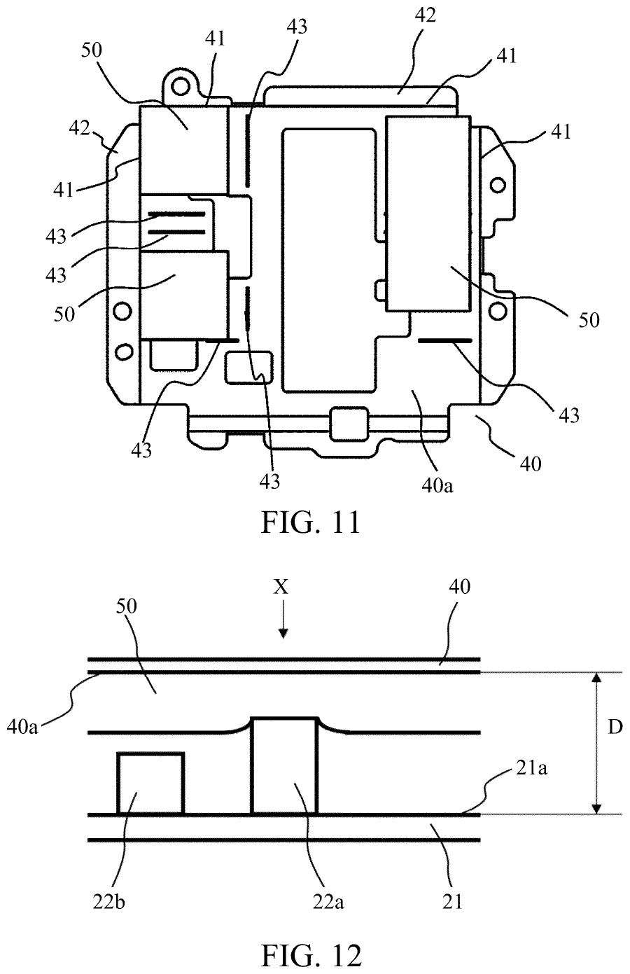

FIG. 11 is a diagram illustrating the attachment position of the heat dissipation sheet 50, with the attachment surface 40a viewed from the object side. For example, by marking a scribe line (position determining unit) 43 on the attachment surface 40a to serve as a reference for positioning the heat dissipation sheet 50, it becomes possible to attach the heat dissipation sheet 50 accurately within the allowable range of misalignment. The scribe line 43 indicates the allowable range of misalignment for the heat dissipation sheet 50. By ensuring that the sheet does not exceed the scribe line 43, the heat dissipation sheet 50 can be attached in the correct position, thereby guaranteeing heat dissipation performance.

Additionally, by positioning and attaching the heat dissipation sheet 50 along a wall of the bent-up portion 41 utilizing the bent-up portion 41, the heat dissipation sheet 50 can be attached with high precision. It is also possible to attach the heat dissipation sheet 50 in contact with the bent-up portion 41 or, as long as it does not exceed the scribe line 43, attach it slightly away from the bent-up portion 41.

When positioning the heat dissipation sheet 50 so that two of its edges are aligned with the bent-up portion 41, it is preferable for a corner formed by these two edges near the bent-up portion 41 to be within the area Y. If the corner is in the area X, the bent-up portion 41 would extend to the corner, resulting in an undesirable increase in the size of the heat dissipation metal plate 40.

Additionally, it is preferable for the second electric element 22, which is relatively tall (height larger than a predetermined value), to be located within the area Y among the plurality of electric elements 22. The heat dissipation sheet 50 has an appropriate compression amount, and if the compression amount becomes too large, the elastic repulsion force becomes excessively high. When the elastic repulsion force due to compressing the heat dissipation sheet 50 increases, there is a risk that the positions of the image sensor 20 and the image sensor holding metal plate 30, which are fixed by the adhesive 60, may shift due to adhesive detachment. As a guideline, it is not preferable to compress more than half the thickness of the heat dissipation sheet 50. The appropriate compression amount for the heat dissipation sheet 50 is about one-fifth of its original thickness, and it is preferable to set it to compress to four-fifths of the original thickness.

When the thickness of the heat dissipation sheet 50 is T, the height of the electric element 22 from the mounting surface 21a is H, and the distance from the mounting surface 21a to the attachment surface 40a is D, the heat dissipation sheet 50 is compressed by an amount of H+T−D and compressed to a thickness of D−H.

Here, it is preferable that the electric element 22 satisfying the inequality D−H<(4/5)×T is placed in the area Y. Among the plurality of electric elements 22 in contact with at least the heat dissipation sheet 50, the tallest first electric element 22a satisfies the above inequality.

In this embodiment, the case where the height H of the electric element 22 is smaller than the distance D from the mounting surface 21a to the attachment surface 40a has been described, but this disclosure is not limited to this case. When the height H is larger than the distance D, that is, when the electric element 22 protrudes beyond the attachment surface 40a, it is likewise preferable that the electric element 22 be located in the area Y. In this case, the value D−H becomes negative, and the above inequality holds. That is, whether the height H is larger or smaller than the distance D, it is preferable to place the second electric element 22, which satisfies the above inequality, in the area Y.

In addition, the electric element 22 with a protrusion extending beyond the attachment surface 40a must be placed in the area Y.

Furthermore, if there are the plurality of tall second electric elements 22, it is preferable that they are arranged as close to each other as possible. This allows a range defined as the area Y to be minimized. The larger area X and the smaller area Y can improve heat dissipation performance.

When placing the tallest first electric element 22a in the area X, it is necessary to reduce the compression amount of the heat dissipation sheet 50. For example, as illustrated in FIG. 12, if the tallest first electric element 22a exists in the area X, it is necessary to position the attachment surface 40a further away from the imaging substrate 21 to reduce the compression amount of the heat dissipation sheet 50. When the heat dissipation metal plate 40 is positioned with the compression amount adjusted to match the tallest first electric element 22a, the distance D from the mounting surface 21a to the attachment surface 40a increases, causing the overall projection toward the image side, and resulting in an increase in the lens barrel 200 size. Additionally, for example, the heat dissipation sheet 50 may not make sufficient contact with a lower electric element 22b, which reduces heat dissipation performance.

In this embodiment, as described above, by placing the tallest first electric element 22a in the area Y, the heat dissipation sheet 50 efficiently contacts the electric elements 22 with varying heights while maintaining an appropriate compression amount. This approach allows for efficient heat dissipation while reducing the load on the electric elements 22 and the adhesive joints between the image sensor 20 and the image sensor holding metal plate 30, caused by the elastic repulsion force of the heat dissipation sheet 50.

For example, when all edges of the heat dissipation sheet 50 are within the area X, with the area Y located at the center, and the tallest first electric element 22a positioned in the area Y, the first electric element 22a presses the heat dissipation sheet 50, causing a portion of the heat dissipation sheet 50 to protrude beyond the attachment surface 40a. This protrusion reduces the compression amount of the heat dissipation sheet 50, which allows for a reduction in elastic repulsion force. However, when the area Y is only at the center and surrounded by the area X, the protruding amount of the heat dissipation sheet 50 may be somewhat limited, posing a risk of not sufficiently reducing the elastic repulsion force.

Thus, it is preferable that at least part of one edge of the heat dissipation sheet 50 is within the area Y. As mentioned above, if the entire perimeter of the area Y is surrounded by the area X, there is a risk of not sufficiently reducing the elastic repulsion force. However, by having part of one edge of the heat dissipation sheet 50 in the area Y, the elastic repulsion force can be reduced without excessively restraining the heat dissipation sheet 50.

The heat dissipation sheet 50 is pressed by the protrusion of the electric element 22 and extends beyond the attachment surface 40a; however, excessive protrusion may lead to issues such as interference with surrounding components or require component arrangements that account for the protruding amount.

Thus, when the tallest first electric element 22a is located on part of a predetermined edge of the heat dissipation sheet 50 within the area Y, it is possible to prevent excessive protrusion of the heat dissipation sheet 50 by setting both sides of the first electric element 22a as the area X. Specifically, it is preferable that at least part of the area between the corner adjacent to the edge in the area Y and the electric element 22 be the area X. If the entire area between the corner adjacent to the edge in the area Y and the electric element 22 is within the area Y, the edge of the corner may easily protrude due to peeling or other factors, which is undesirable.

Additionally, it is preferable that at least part of each edge of the heat dissipation sheet 50 be within the area X. This configuration helps reduce edge peeling. If all edges are within the area Y, there is a higher likelihood of peeling, which may lead to concerns such as interference with external components.

As described above, the configuration of this embodiment allows for providing the image pickup apparatus capable of precisely maintaining the position of the image sensor 20, reducing the load from the elastic repulsion force of the heat dissipation sheet 50, and ensuring efficient heat dissipation functionality.

While the disclosure has described example embodiments, it is to be understood that some embodiments are not limited to the disclosed embodiments. The scope of the following claims is to be accorded the broadest interpretation so as to encompass all such modifications and equivalent structures and functions.

According to the present disclosure, it is possible to provide the image pickup apparatus that achieves load reduction on the image sensor, improved heat dissipation functionality, and high-precision positioning of the image sensor.

This application claims priority to Japanese Patent Application No. 2023-218001, which was filed on Dec. 25, 2023, and which is hereby incorporated by reference herein in its entirety.

What is claimed is:

1. An image pickup apparatus comprising:
an image sensor configured to image an object image formed by an optical system;
a substrate arranged on an image side of the image sensor;
a plurality of electric elements mounted on a mounting surface on the image side of the image sensor, each with a different protruding amount from the mounting surface;
a heat dissipation sheet in contact with the plurality of electric elements; and
a heat dissipation member arranged to sandwich the heat dissipation sheet with the substrate,
wherein the heat dissipation member includes an attachment surface in contact with the heat dissipation sheet,
wherein part of the heat dissipation sheet is pressed by part of the plurality of electric elements and the attachment surface,
wherein, when viewed from the image side, the image pickup apparatus includes a first area where the heat dissipation sheet overlaps with the heat dissipation member and a second area where the heat dissipation sheet is exposed without overlapping with the heat dissipation member, and
wherein, among the plurality of electric elements in contact with the heat dissipation sheet, a first electric element with the largest protruding amount is located in the second area.

2. The image pickup apparatus according to claim 1, further comprising a holding member arranged around the image sensor with a predetermined gap,
wherein the image sensor is fixed to the holding member by filling the gap with an adhesive, and
wherein the adhesive is applied to an object side surface of the holding member.

3. The image pickup apparatus according to claim 1, wherein the following inequality is satisfied:
D−H<(4/5)×T
where H is the protruding amount of the first electric element from the mounting surface, D is a distance from the mounting surface to the attachment surface, and T is a thickness of the heat dissipation sheet.

4. The image pickup apparatus according to claim 1, wherein a plurality of second electric elements, among the plurality of electric elements, having a protruding amount larger than a predetermined value, are located within the same second area.

5. The image pickup apparatus according to claim 1, further comprising a holding member arranged around the image sensor with a predetermined gap,
wherein positions of the image sensor, the substrate, the holding member, the heat dissipation sheet, and the heat dissipation member are adjusted integrally.

6. The image pickup apparatus according to claim 1,
wherein a connector is arranged on the mounting surface, and
wherein the heat dissipation sheet is arranged on both sides of the connector when viewed from the image side.

7. The image pickup apparatus according to claim 1, further comprising a holding member arranged around the image sensor with a predetermined gap,
wherein the heat dissipation member includes a bent-up portion extending toward an object side from an end of a flat portion that includes the attachment surface, and a flange portion extending outward in a direction perpendicular to an optical axis of the optical system from an end of the bent-up portion, and
wherein the flange portion is in contact with the holding member and is fixed to the holding member while being in contact with the holding member.

8. The image pickup apparatus according to claim 7,
wherein a plurality of position determining units are provided on the attachment surface, and
wherein the heat dissipation sheet is arranged within an area enclosed by the plurality of position determining units and the bent-up portion when viewed from the image side.

9. The image pickup apparatus according to claim 1, wherein a shape of the heat dissipation sheet is rectangular.

10. The image pickup apparatus according to claim 1, wherein at least part of each side of the heat dissipation sheet is located within the first area when viewed from the image side.

11. The image pickup apparatus according to claim 9,
wherein the heat dissipation member includes a bent-up portion extending toward an object side from an end of a flat portion that includes the attachment surface, and
wherein a corner formed by two sides of the heat dissipation sheet adjacent to the bent-up portion is located in the second area when viewed from the image side.
